(19) United States
(12) Patent Application Publication
(10) Pub. No.: US 2017/0232887 A1
(43) Pub. Date: Aug. 17, 2017

(54) Baby Safety Alarm

(71) Applicant: Debora A. Clontz, Austin, IN (US)

(72) Inventor: Debora A. Clontz, Austin, IN (US)

(21) Appl. No.: 15/044,108

(22) Filed: Feb. 16, 2016

(51) Int. Cl. B60Q 5/00; B60R 1/00; B60N 2/00

(52) U.S. Cl. CPC B60Q 5/005; B60N 2/002; B60R 1/00; B60R 2300/80

(57) ABSTRACT

A safety alarm system is disclosed for protecting children and other occupant left unattended in a vehicle from potentially dangerous high temperature in the vehicle. The safety alarm system includes an alarm, a control unit, an on/off switch, and a sensor pad. The sensor pad including a pressure sensor and a heat sensor may be permanently installed in the seat or as an easily attachable portable pad which can connect with other components of the safety alarm system. The control unit includes a memory and a microprocessor. The safety alarm system can be activated by fastening safety belt of the seat including the sensor pad. The control unit is programmed to generate sound alert on different conditions stored in the memory and pressure data received from the pressure sensor, the ambient temperature data received from the heat sensor, status of vehicle's engine, gear system, driver's vehicle door and safety belt.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of Invention

The present invention generally relates to a safety alarm system. More particularly, the present invention relates to “a safety alarm system for protecting child or other occupant left unattended in a vehicle”.

(2) Background of Invention

Very frequently the infants and children are left in the vehicle unattended. The temperature in a closed vehicle tend to rise and may reach a dangerous level to cause death of the infant or children left inside the vehicle. This situation may also arise if a pet or an elderly is left unattended in the vehicle. Also, the infant or children if left unattended in car by parents absent mindedly, the infant or children may also be subjected to injury or abduction. Hence there is a need for a method to alert parents or driver if a child, infant, pet or elderly is left unattended in the vehicle. There have been some systems which try to solve this problem. For example, U.S. patent application Ser. No. 10/160,648 discusses an occupancy alarm system to generate an alarm if the engine of vehicle is turned off and there is still an occupant in the vehicle. Similarly, U.S. Pat. No. 7,348,880 B2 issued to Delphi Technologies, Inc. on 2008, Mar. 25, discloses a system for alerting an emergency system about the presence of an occupant in high temperature inside a motor vehicle. Also, U.S. Pat. No. 8,038,213 B2 issued to Chelsea Owens on 2011, Oct. 18, discloses a child safety seat system configured to detect presence of child and generating an alert. However, these systems are either not efficient in fully secure the safety of an unattended occupant or are difficult to use. It is desired that a safety system is provided which can provide complete protection to an unattended occupant. It is further desired that the system is portable to be used with different vehicles. Furthermore, the system should be available for installation during manufacturing of vehicle as well as for after-market modification in a vehicle.

It is an aspect of the invention to overcome or alleviate a problem of the prior art.

This permits the use of the present invention which enhance the prior art of the system for protecting a child and other occupant left unattended in a vehicle.

### BRIEF SUMMARY OF THE INVENTION

In view of the foregoing, one aspect of the various disclosed embodiments in the present invention is to provide a safety alarm system for protecting children or other occupant left unattended in a vehicle from potentially dangerous high temperature in the vehicle.

Preferably the safety alarm system addresses, or at least ameliorates one or more of the problems described above. To this end, the present invention related to a safety alarm system, with some unique aspects is disclosed.

Accordingly, it is a primary object of the present invention to provide a safety alarm system for protecting children left in a vehicle from potentially dangerous high temperature in the vehicle. The safety alarm system includes an alarm, a control unit, an on/off switch, and a sensor pad. The safety alarm system can be used to protect pets and elderly as well.

It is another object of the present invention that the safety alarm system allows a user to change factors for conditions for generating a sound alert.

It is yet another object of the present invention that the sensor pad of the safety alarm system is portable.

It is still another object of the present invention that the safety alarm system can be installed during manufacturing of the vehicle or can be installed as an after-market modification.

Other objects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 shows side cross-sectional view of a control unit of a safety alarm system installed in a vehicle;

FIG. 2 shows a top perspective view of a sensor pad installed in a seat.

### DETAIL DESCRIPTION OF THE INVENTION

The following detailed description of the present invention is enabling teaching of the invention and its best, currently known embodiment. Those skilled in the art can understand that many changes can be made in the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made and may be desired in certain circumstances, and are part of the present invention. Thus, the following description is provided as illustrative of the principle of the present invention.

Embodiments of the present invention provide a safety alarm system for protecting children left in a vehicle from potentially dangerous high temperature in the vehicle. Accordingly, the specific embodiments discussed herein are merely illustrative of specific manners in which to make and use this invention, and are not intended to represent an exhaustive list of all possible structure and processes of the present invention.

Embodiments of the safety alarm system are shown in the figures, and discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

Aspects of the present inventive subject matter are described with reference to the figures.

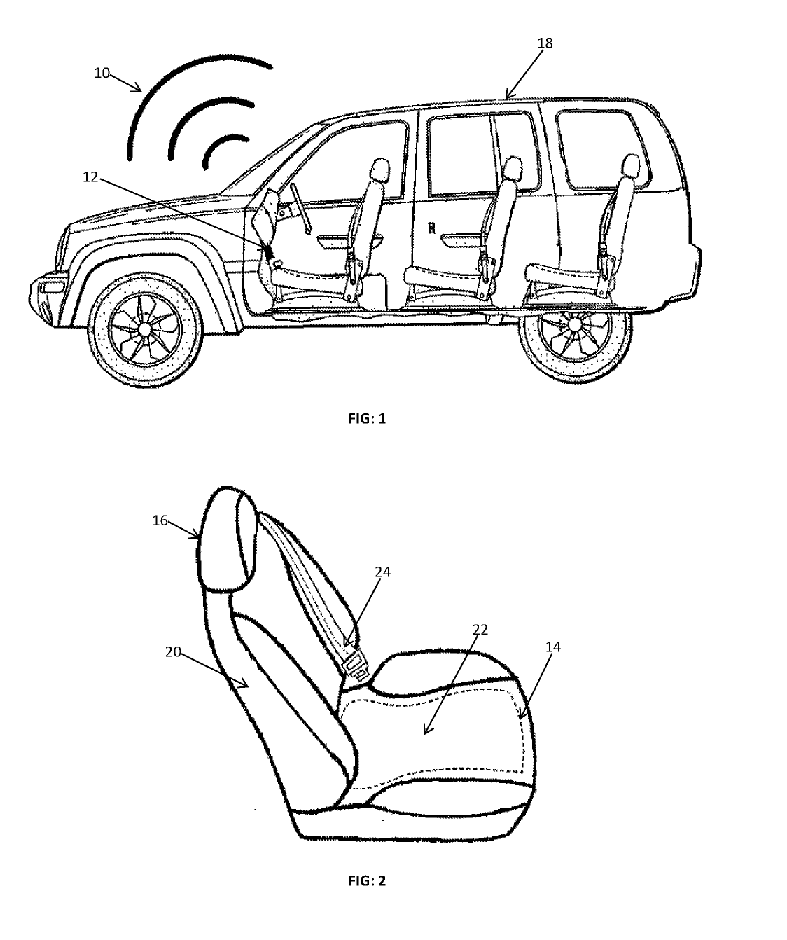

The present invention provides for a safety alarm system for protecting children or other occupant left unattended in a vehicle from potentially dangerous high temperature in the vehicle. Referring to FIG. 1 showing a preferred embodiment of the present invention, the safety alarm system 10 includes an alarm, a control unit 12, an on/off switch, and a sensor pad 14. The sensor pad 14 is installed in a seat 16 to be occupied by a child. The sensor pad 14 is preferably installed in the back seat of the vehicle 18. The sensor pad 14 has two parts where first part of the pad is installed on the back support 20 of the seat 16, and second part is installed on the sitting area 22 of the seat 16 as shown in FIG. 2. The sensor pad 14 may be permanently installed in the seat 16 or may be provided as a portable pad which can be easily attached to the seat 16 and connect with other components of the safety alarm system 10. The sensor pad 14 may be installed permanently in the seat 16 in a number of ways known in the art. Preferably the sensor pad 14 is sewn into the seat 16 under the outside cover. The sensor pad 14 includes a pressure sensor and a heat sensor. The pressure sensor detects the pressure on the sensor pad 14. When the sensor pad 14 is installed on the seat 16 of the vehicle 18, the pressure sensor detects the weight of the child sitting on the seat 16. The pressure sensor has high sense capabilities and can detect the change in weight on the sensor pad 14 as little as 10 pounds. The heat sensor of the sensor pad 14 detects the temperature of the surrounding near the sensor pad 14 i.e. ambient temperature. Both the pressure sensor and the heat sensor send the detected pressure data and ambient temperature data respectively to the control unit 12. The sensor pad 14 may be connected to the control unit 12 by wired or wireless system. The wired system connecting the sensor pad 14 with the control unit 12 has wires installed in the seat and vehicle body. The control unit 12 is connected to the electronic control system of the vehicle 18. The control unit 12 is also connected to the alarm by wire. The control unit 12 is further connected to the on/off switch by wire. The on/off switch can start and shut down the operation of the safety alarm system. The on/off switch is preferably installed on the driver's vehicle door. The control unit 12 is also further connected to the driver's vehicle door system with wire. The closing of the driver's vehicle door completes the electric circuit of the wire connection with the control unit 12 to indicate the closed status of the driver's vehicle door. The opening of the driver's vehicle door breaks the electric circuit of the wire connection with the control unit 12 and thereby indicates the open status of the driver's vehicle door. The control unit 12 is further connected by wire to the safety belt 24 of the seat 16 including the sensor pad 14. When the control unit 12 is switched on, the safety alarm system can be activated by fastening the safety belt 24. The activation mechanism works by completion of electric circuit of the wire connecting the safety belt 24 with the control unit 12 where the male and female members of the safety belt 24 when joined together form a connection between two ends of the wire. The completed electric circuit through the safety belt 24 indicates the fastened status of the safety belt 24 and thus indicates the presence of the child in the seat 16 to the control unit 12. The disconnected electric circuit through the safety belt 24 indicates the unfastened status of the safety belt 24 and thus indicates the absence of the child in the seat 16 to the control unit 12. The control unit 12 is further connected to the engine and gear system of the vehicle 18 to detect whether the transmission of the vehicle 18 is shifted to park or engine shut off. The control unit 12 may be preferably installed beneath the dashboard of the vehicle 18 as shown in FIG. 1. The control unit 12 has a memory which stores conditions for generating the sound alert. Upon activation of the safety alarm system, the control unit 12 is programmed to generate sound alert on different conditions stored in the memory. The control unit 12 also has a microprocessor which is programmed to identify the fulfillment of the condition for generating the sound alert by using the pressure data received from the pressure sensor, the ambient temperature data received from the heat sensor, data from the engine of the vehicle, data from the gear system, electric circuit data from the driver's vehicle door and electric circuit data from safety belt 24 of the seat including the sensor pad 14. When the control unit 12 identifies that a condition for generating the sound alert is fulfilled, the control unit 12 send signal to the alarm to raise the sound alert.

In an exemplary condition for generating the sound alert, the pressure sensor does not indicate change in weight on the seat, the wire connection between the control unit and the driver's vehicle door indicate open status and then closed status of the driver's vehicle door, thereby indicating the absence of the driver in the vehicle while the child is present in the vehicle. In this case, the user after entering the vehicle fastens the seat belt around the child and turns the safety alarm system. The fastened status of the seat belt automatically activates the safety alarm system and allows the control unit to receive the pressure data and ambient temperature data from the sensor pad. Now, when the user opens and closes the driver's vehicle door to leave the vehicle, the safety alarm system notices that the new data from pressure sensor does not indicate a change in weight on the seat to indicate presence of the child in the vehicle; the safety alarm system generates the sound alert. In another exemplary condition for generating the sound alert, the safety belt is in fastened status, the pressure sensor does not indicate change in weight on the seat, the transmission of the vehicle is shifted to parked or engine shut off, the open status and then closed status of the driver's vehicle door. In this case, the safety alarm system identifies that the vehicle is not being driven, driver has left the vehicle, and the child is still in the vehicle. The safety alarm system thus generates the sound alert. In yet another exemplary condition for generating the sound alert, the ambient temperature is at least equal to predetermined ambient temperature and the pressure sensor does not indicate change in weight on the seat. This sound alert will be raised even if the user is still in the vehicle and thus notifies that the temperature in the vehicle may be too high for the comfort of the child. The predetermined ambient temperature may be preferably set at 75° Fahrenheit or 80° Fahrenheit.

These conditions are only for exemplification purpose and do not limit the scope of the present invention. The safety alarm system may be configured with other conditions for generating the sound alert using the pressure data received from the pressure sensor, the ambient temperature data received from the heat sensor, data from vehicle's engine, data from gear system, electric circuit data from driver's vehicle door and electric circuit data from safety belt of the seat including the sensor pad, in any combination which indicates a potential threat from high ambient temperature to the child in the vehicle.

The control unit may be programmed to generate the sound alert immediately or within a predetermined period of time after a condition of generating sound alert is fulfilled. The user may set the value of the predetermined period of time for example, 10 seconds, 20 seconds, 30 seconds or 1 minute. In a preferred embodiment of the present invention, the control unit includes a display to show ambient temperature detected by the heat sensor. The display may include the input means to set the predetermined ambient temperature as a condition for generating sound alert, the predetermined period of time for generating sound alert. The display may also include the on/off switch. The input means may be provided as a keypad or as a touchscreen. The safety alarm system preferably draws electrical power from the electrical system of the vehicle via the electronic control system. Alternatively, the safety alarm system may include one or more batteries. The batteries may be rechargeable and replaceable. In another preferred embodiment of the present invention, the control unit of the safety alarm system is further programmed to connect to the GPS of the vehicle and send the location of vehicle to the emergency response system or police if the pressure sensor does not indicate change in weight on the seat and the safety alarm system has not been deactivated in a predetermined period of time after generation of sound alert.

The control unit, the pressure sensor, and body sensor are preferably manufactured from rigid, durable material such as but not limited to steel, plastic, aluminum alloy, copper alloy, and acrylic polymer. The car safety seat and the sensor pad are preferably manufactured from flexible, durable material such as but not limited to foam rubber, covered with a flexible, durable and water resistant material such as but not limited to vinyl or plastic and mounted on a frame which is preferably manufactured from a rigid, durable material such as but not limited to steel or aluminum alloy. The wires are preferably manufactured from braided copper alloy wire sheathed in plastic. The safety alarm system can be installed in the vehicle during manufacturing of the vehicle or it can be installed in the vehicle as an after-market modification by the owner or by a repair or customizing shop. It should be noted that though the safety alarm system of the present invention has been discussed here for children, the safety alarm system may also be used to protect pets and elderly if they left in the vehicle.

It is to be understood that the above description is intended to be illustrative, and not restrictive. For example, the above discussed embodiments may be used in combination with each other. Many other embodiments will be apparent to those of skill in the art upon reviewing the above description.

Whereas, the construction and method have been described in relation to the figures of the drawings, it should be understood that other and further modifications, apart from those shown or suggested herein, may be made within the spirit and scope of this invention.

1. A safety alarm system for detecting an unattended occupant in a vehicle, the safety alarm system comprising:
an alarm to generate a sound alert;
a portable sensor pad attachable to a selected seat of the vehicle, and comprising a first part configured to be installed on a back support of the selected car seat and a second part configured to be installed on a sitting area of the selected car seat, the sensor pad including a pressure sensor and a heat sensor,
a control unit including a memory, a microprocessor, and an on-off switch locating in driver's door;
said control unit being connected to said alarm said sensor pad, to a safety belt of the seat, to an engine of the vehicle, to a gear system of the vehicle, and said control unit being configured to receive pressure data from said pressure sensor, ambient temperature data from said heat sensor, data from said engine, data from said gear system, electric circuit data from said driver's vehicle door and electric circuit data from said safety belt;
said memory configured to store a predetermined ambient temperature and a condition to generate the sound alert by using combination of said pressure data, said ambient temperature data, said data from said engine, said data from said gear system, said electric circuit data from said driver's vehicle door and said electric circuit data from said safety belt;
wherein said safety alarm system is connected to electronic control system of said vehicle.

2. The safety alarm system of claim 1, wherein said control unit is connected to sensor pad by wire.

3. The safety alarm system of claim 1, wherein said control unit connected to said sensor pad by wireless connection.

4. The safety alarm system of claim 1, wherein said control unit further includes a display showing said ambient temperature detected by said heat sensor.

5. The safety alarm system of claim 1, wherein said control unit further includes a display showing said ambient temperature detected by said heat sensor, said display including a keypad to set said predetermined ambient temperature.

6. The safety alarm system of claim 1, wherein said control unit further incudes a display showing said ambient temperature detected by said heat sensor, said display including touchscreen to set said predetermined ambient temperature.

7. The safety alarm system of claim 1, wherein said safety alarm system includes batteries to supply power to said safety alarm system.

8. The safety alarm system of claim 1, wherein said safety alarm system includes rechargeable and replacable batteries to supply power to said safety alarm system.

9. The safety alarm system of claim 1, wherein said condition to generate a sound alert include said pressure sensor not indicated change in weight on said seat, the electric circuit between said control unit and said driver's vehicle door indicating open status and then closed status of said driver's vehicle door.

10. The safety alarm system of claim 1, wherein said condition to generate a sound alert include said ambient temperature being at least equal to said predetermined ambient temperature and said pressure sensor not indicating change in weight on said seat.

11. The safety alarm system of claim 1, wherein said condition to generate a sound alert include said ambient temperature being at least equal to said predetermined ambient temperature and said pressure sensor indicating change in weight on said seat.

12. The safety alarm system of claim 1, wherein said control unit sends signal to alarm to generate sound alert after a predetermine period of time, said memory stores a predetermined period of time.

13. The safety alarm system of claim 1, wherein said control unit sends signal to alarm to generate sound alert after a predetermined period of time, said control unit further including a display, said display including a keypad to set said predetermined period of time, said memory stores a predetermined period of time.

14. The safety alarm system of claim 1. wherein aid control unit send single to alarm to generate sound alert after a predetermine period of time, said control unit further including a display, said display including a touchscreen to set said predetermined period of time, said memory stores a predetermined period of time.

15. The safety alarm system of claim 1, wherein said control unit send signal to alarm to generate sound alert after a predetermined period of time, said memory stores a predetermined period of time, aid predetermined period of time is 10 seconds.

16. A safety alarm system of claim 1, wherein said predetermined ambient temperature is set at 75° Fahrenheit.

17. A safety alarm system of claim 1, wherein said predetermined ambient temperature is set to 80° Fahrenheit.

18. The safety alarm system of claim 1, wherein unattended occupant is an infant.

19. The safety alarm system of claim 1, wherein unattended occupant is a child.

20. The safety alarm system of claim 1, wherein unattended occupant is a pet.

21. The safety alarm system of claim 1, wherein unpatented occupant is an elderly.
